(19) United States
(12) Patent Application Publication
(10) Pub. No.: US 2016/0109722 A1
(43) Pub. Date: Apr. 21, 2016

(54) IMPROVEMENTS IN, OR RELATED TO, EYE GLASS FRAMES

(71) Applicant: Ashleigh MCKEGG, Remuera, Auckland (NZ)

(72) Inventor: Ashleigh McKegg, Remuera (NZ)

(21) Appl. No.: 14/894,909

(22) PCT Filed: Jan. 10, 2014
(86) PCT No.: PCT/NZ2014/000004

§ 371 Date: Nov. 30, 2015

(30) Foreign Application Priority Data
May 31, 2013 (NZ) 611385

(51) Int. Cl. G02C 5/00; G02C 5/20; G02C 3/04; G02C 5/22; G02C 5/14; G02C 5/08; G02C 5/16

(52) U.S. Cl. CPC G02C 5/006; G02C 5/08; G02C 5/20; G02C 5/008; G02C 5/16; G02C 5/2263; G02C 5/146; G02C 3/04; G02C 2200/14; G02C 2200/16

(57) ABSTRACT

The invention is for a glasses frame to lenses for a user's eye. The frame has a first and second lens holding portions adapted to each hold a lens, the portions having at least one hinge between them. A first arm extends from the first lens holding portion on an edge thereof distal from the hinge, and a second arm extends from the second lens holding portion on another edge thereof distal from the hinge. The glasses frame has an unfolded position whereby the first and second lens holding portions are extended on said hinge to enable location of the lenses in front of each eye and the arms extend backward from the frame to engage with a head of the user, and a folded position whereby the first and second lens holding portions are contracted about the hinge to lie toward or adjacent each other and the arms fold such that a free end of each folds towards the hinge to thereby capture and retain the glasses frame to an elongate object.

### TECHNICAL FIELD OF THE INVENTION

The present invention relates to frames for glasses.

In particular, though not solely, the present invention is directed to an eye glass frame that can be worn on the face and then manipulated to wrap around an elongate object, for example, but not limited to, a wrist or arm.

### BACKGROUND OF THE INVENTION

Glasses normally have a pair of arms that are hinged from the frame that holds the lenses of the glasses. The purpose of the hinge, at least in part is to allow folding of the arms substantially into the plane of the frame when not in use. Such hinges are often a weak point of glasses frame design.

There are known arms and hinges that are sprung to give some resilience to the hinge and also account for bending out of the arms.

A problem with many glasses, for example reading or sun glasses, is they are not on the face all the time. Often a user will wear them for only brief periods of time, for example when in the sun, or when reading, but will take them off otherwise. In these situations the user must find a location for the glasses once removed. Placing them on top of the head may interfere with hair, or a hat, or they may simply fall off. Hanging them from places allows them to move and dangle about and may be a nuisance or even a hazard. Taking them off and stowing them in a glasses case can be relatively time consuming, especially if they are on again off again, and then requires the user somehow to retain the glasses case separately. In situations where the user takes the glasses on and off regularly there is a risk they may also put them down. Should they do so, then there is a real chance of forgetting them or leaving them behind. The result is they are not easily on hand when needed again, or worse they may become lost.

There is therefore a need for a glasses frame that can be removed and easily stowed either on the person themselves, or an object of theirs, easily repeatably and in the knowledge they are securely retained until they are needed again. Removal, stowing and then removing and applying to the users face should also be easy and not complicated.

In this specification where reference has been made to patent specifications, other external documents, or other sources of information, this is generally for the purpose of providing a context for discussing the features of the invention. Unless specifically stated otherwise, reference to such external documents is not to be construed as an admission that such documents, or such sources of information, in any jurisdiction, are prior art, or form part of the common general knowledge in the art.

It is an object of the present invention to provide an improved eye glass frame or to overcome the above shortcomings or address the above desiderata, or to at least provide the public with a useful choice.

### BRIEF DESCRIPTION OF THE INVENTION

In a first aspect the present invention may be said to broadly consist in a glasses frame adapted to hold at least a pair of lenses, one each for an eye of a user, comprising or including,
A first lens holding portion and a second lens holding portion adapted to each hold a said lens, having at least one hinge therebetween,
A first arm extending from said first lens holding portion on an edge thereof distal from said hinge, and a second arm extending from said second lens holding portion on an edge thereof distal from said hinge,
Wherein said glasses frame has
an unfolded position whereby said first lens holding portion and said second lens holding portion are extended on said hinge to enable location of said lenses in front of each said eye and said arms extend backward from said frame to engage with a head of said user, and
a folded position whereby said first lens holding portion and said second lens holding portion are contracted about said hinge to lie toward or adjacent each other and said arms fold such that a free end of each folds towards said hinge to thereby enable capture and retention of said glasses frame to an elongate object.

Preferably an axis of movement of said at least one hinge is substantially perpendicular to a major surface of said first and second lens holding portions when in said unfolded position.

Alternatively an axis of movement of said at least one hinge is substantially parallel to a major surface of said first and second lens holding portions when in said unfolded position.

Preferably said first lens holding portion and said second lens holding portion when in said folded position lie side by side each other.

Alternatively said first lens holding portion and said second lens holding portion when in said folded position lie substantially one on top of each other.

Preferably said first and said second arm extend substantially parallel to each other at least when in said unfolded position.

Preferably said arms at least in part comprise a bi-stable material that extends for said unfolded position, and that folds or wraps for said folded position.

Preferably said bi-stable material is a plastics, composites or metal material.

Preferable said bi-stable material is coated with a soft or rubber like material.

Preferably each said lens holding portion extends substantially all the way about each said lens.

Alternatively each said lens holding portion extends only part way around each said lens.

Preferably each said lens holding portion is a unitary part.

Alternatively each said lens holding portion is comprised of multiple parts.

Preferably said at least one hinge is at least in part biased to either or both said folded or unfolded positions.

Preferably said glasses frame can lock or be retained in either or both said folded and said unfolded positions.

Preferably said lock or retention is at least in part achieved by said at least one hinge.

Preferably at least when in said folded position said lenses are substantially covered, for example to prevent them becoming contaminated or scratched.

Preferably there are two said hinges.

Preferably said hinge has two hinge axes distal from each other and connected therebetween by a hinge portion.

Preferably said hinge axes are parallel to each other and line parallel to said major surface.

Preferably each of said two hinges is located either side of a nose piece that is intermediate each of said lens holding portions.

Preferably each said arm portion is selectively detachable from their respective said lens holding portion.

Preferably said lenses are selected from any one or more of
prescription lenses,
sunglass lenses, and
protective lenses.

Preferably said elongate object is a part of a user's body, for example an arm, wrist or leg.

Alternatively said elongate object is a strap, handle or similar.

Preferably said arms angle or curve inwardly toward each other when in the unfolded position.

In another aspect the present invention may be said to broadly consist in a glasses frame, comprising or including,
A first lens holding portion and a second lens holding position located either side of at least one hinge therebetween,
A first arm extending from said first lens holding portion at a location distal from said hinge,
A second arm extending from said second lens holding portion at a location distal from said hinge,
Said glasses frame having,
a first position whereby said lens holding portions and said arms are extended to enable location of said glasses frame on an users head, and
a folded position whereby said lens holding portions are rotated to locate adjacent one another, and said arms can curl to thereby hold said glasses frame to an elongate object.
Preferably said lens holding portions and said arms in act in conjunction to hold said glasses frame to said elongate object.

In yet another aspect the present invention may be said to broadly consist in a method of use of a glasses frame, comprising or including the steps of,
Folding a first lens holding portion and a second lens holding portion about a hinge therebetween such that said lens holding portions lie adjacent one another,
Folding a first arm, extending from said first lens holding portion and a second arm extending from said second lens holding portion,
Allowing said folded first arm and said folded second arm to wrap or otherwise locate about an elongate object,
And vice versa,
Such that said glasses frame can be stored in a folded position on said elongate object, and then unfolded for use.

In another aspect the present invention may be said to broadly consist in a glasses frame as described herein with reference to any one or more of the accompanying drawings.

In another aspect the present invention consists in a method of use of a glasses frame as described herein with reference to any one or more of the accompanying drawings.

As used herein the term “and/or” means “and” or “or”, or both.

As used herein “(s)” following a noun means the plural and/or singular forms of the noun.

The term “comprising” as used in this specification means “consisting at least in part of”. When interpreting statements in this specification which include that term, the features, prefaced by that term in each statement, all need to be present, but other features can also be present. Related terms such as “comprise” and “comprised” are to be interpreted in the same manner.

It is intended that reference to a range of numbers disclosed herein (for example, 1 to 10) also incorporates reference to all rational numbers within that range (for example, 1, 1.1, 2, 3, 3.9, 4, 5, 6, 6.5, 7, 8, 9 and 10) and also any range of rational numbers within that range (for example, 2 to 8, 1.5 to 5.5 and 3.1 to 4.7).

The entire disclosures of all applications, patents and publications, cited above and below, if any, are hereby incorporated by reference.

To those skilled in the art to which the invention relates, many changes in construction and widely differing embodiments and application of the invention will suggest themselves without departing from the scope of the invention as defined in the appended claims. The disclosures and the descriptions herein are purely illustrative and are not intended to be in any sense limiting.

Other aspects of the invention may become apparent from the following description which is given by way of example only and with reference to the accompanying drawings.

### BRIEF DESCRIPTION OF THE DRAWINGS

Preferred forms of the present invention will now be described with reference to the accompanying drawings in which;

FIG. 1 Shows a perspective view of a first embodiment of the present invention,

FIG. 2 Shows a perspective view of the embodiment of FIG. 1 where the lens holding portions have been folded about the hinge, but the arms remain extended,

FIG. 3 Shows a plan view of the glasses frame,

FIG. 4 Shows an end on perspective view of the FIG. 2,

FIG. 5 Shows a perspective view of the invention wrapped about an elongate object, in this case the wrist of a user,

FIG. 6 Shows a further embodiment of the present invention in close up perspective of the lens holding portions using only a single hinge, partially folded,

FIG. 7 Shows one embodiment of the present invention where the folding of the lens holding portions allows them to lie toward each other and the glasses frame is shown wrapped about a user's wrist,

FIG. 8 Shows an alternative embodiment of the arms whereby they are piece-wise bendable, such that their folding is controlled,

FIG. 9 Shows a corner perspective of the removable arms,

FIG. 10 Shows a close up of the detachable arm or FIG. 9,

FIG. 11 Shows a further embodiment of the present invention with a hinge to allow the lens holding portions lie one of top of another, in isometric sequence at (A) the lens holding portions unfolded for normal use, (B) partway to being folded, and (C) folded completely on top of each other,

FIG. 12 Shows the embodiment in FIG. 11, in plan view sequence at (A) the lens holding portions unfolded for normal use, (B) partway to being folded, and (C) folded completely on top of each other,

FIG. 13 Shows a further variation of the present invention in front isometric view that uses a hinge portion as part of the hinge, in the unfolded position,

FIG. 14 Shows a further of FIG. 13 in a position midway between unfolded, and folded in front isometric view,

FIG. 15 Shows a further view of FIG. 13 with the glasses frame in the folded position,

FIG. 16 Shows a rear isometric view of the further variation midway between unfolded and unfolded,

FIG. 17 Shows a top view of the further variation at (A) unfolded, (B) midway folded, and (C) folded,

FIG. 18 Shows a front view of the further variation at (A) unfolded, (B) midway folded, and (C) folded,

FIG. 19 Shows an isometric view of the folded glasses frames with the arm folded, or wrapped,

FIG. 20 Shows a side view of FIG. 19, and

FIG. 21 Shows the further variation captured and retained on an elongate object, in this case a user's wrist.

### DETAILED DESCRIPTION OF THE INVENTION

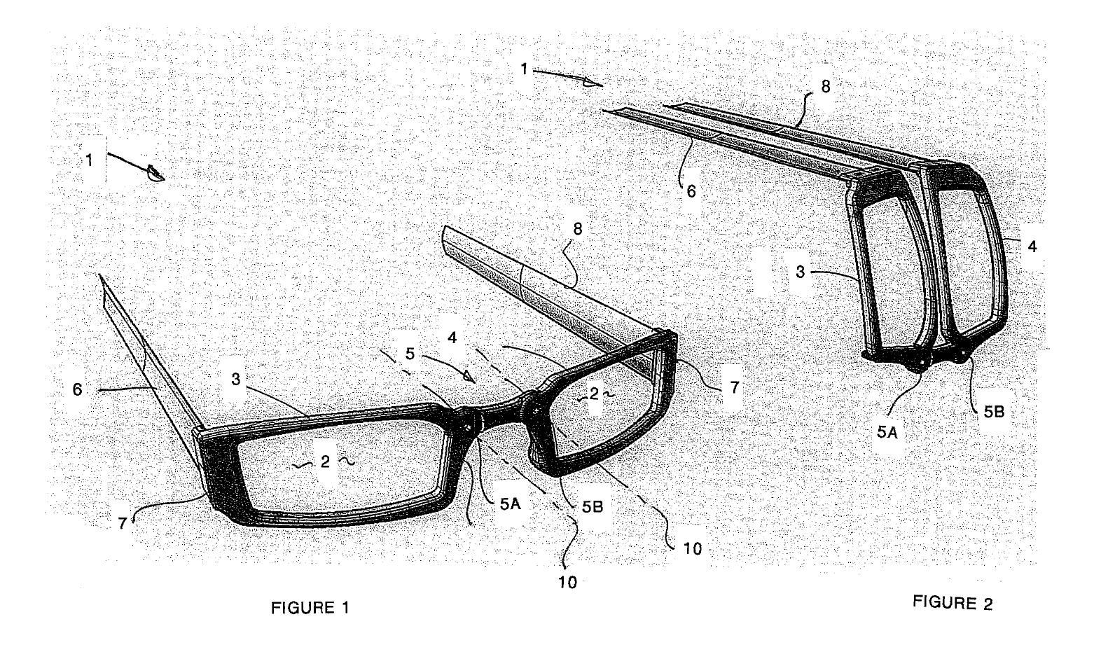

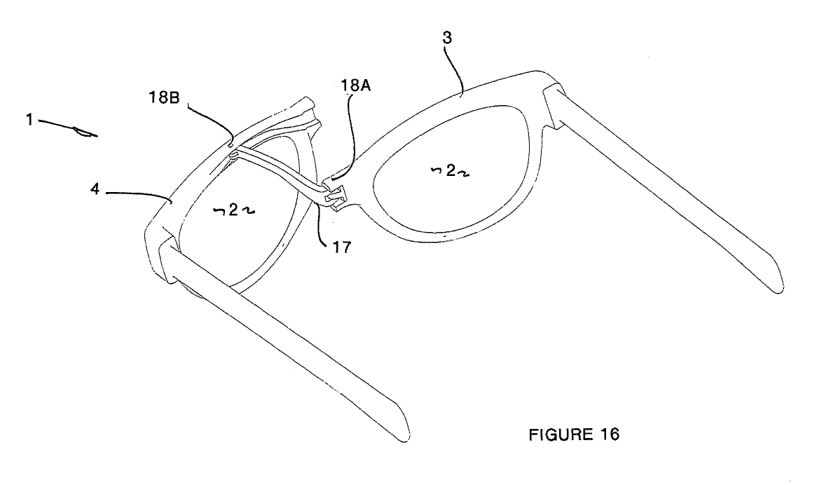

Preferred embodiments will now be described with reference to FIGS. 1 through 22.

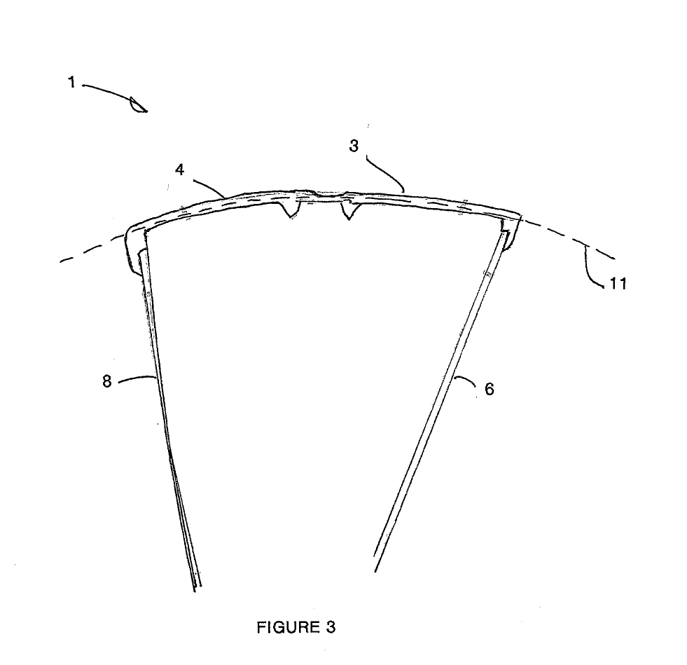

A glasses frame 1 as shown in FIGS. 1 and 2 consists of a first lens holding portion 3 and second lens holding portion 4. Each of the lens holding portions is capable of holding a lens 2. The lens 2 may be any one or more of a prescription lens, sunglass lens, protective lens, cosmetic lens or otherwise. The lens holding portions 3 and 4 as shown are unitary and completely surrounding the lens 2. In other forms they may be multipart and/or multi-material. In other firms they may only partially surround the lens 2, for example they may be screwed or otherwise fasten to the lens 2. The lens holding portions may be made in variety of materials, for example steel, plastic, alloy or composites or other traditional materials. The lens holding portions may be made in a variety of know techniques for example injection moulding for plastic, or stamping or forging for metals.

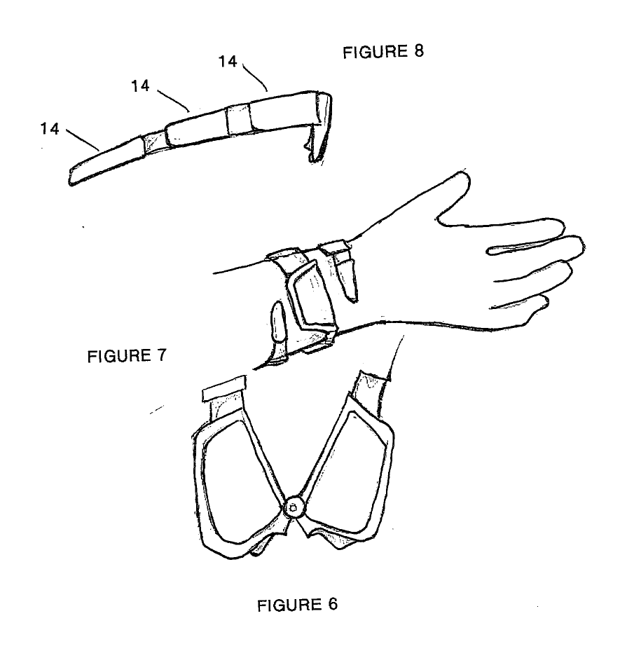

Between the portions 3 and 4 is a hinge 5. In this case the hinge consists of a double hinge having pivot points 5A and 5B, which are located either side of a nose piece 13. The nose piece 13 connects each of the portions 3 and 4. The hinge as shown has an axis of movement 10 that is perpendicular to the major surface 11 shown in FIG. 3 of the lens holding portions. This surface may be planar or curved; in FIG. 3 it is curved. In other forms of the invention the hinge may consist of only one hinge point, such as shown in FIG. 6. The hinge may be biased to an open or closed position or both. There may also be a locking mechanism for either open or closed position. Friction may also be employed to lock the hinge in the open, closed, or both positions.

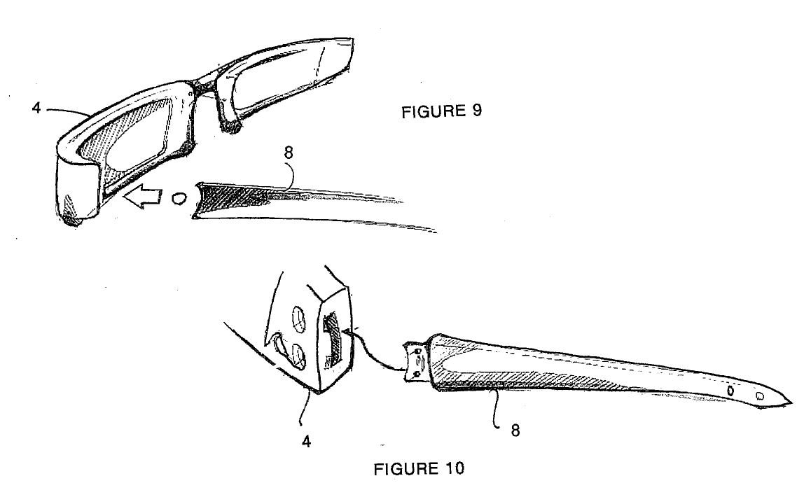

Extending from edges 7 that are distant from the hinge 10 are first arm 6 and second arm 8. The arms are at least in part, and in one embodiment completely, made from a bi-stable material. Such a material holds its elongate form as shown in FIG. 1, but when displaced beyond a certain point, loose that form and will revert to another form, for example a curved or curled form, such as shown in part in FIG. 5, where they are shown wrapped about the wrist 9. The displacement is normally out of the plane of their elongate form and may be initiated at any point along their length, including the ends or the middle. The arms 6 and 8 are preferably parallel to each other in the state shown in FIG. 1 and in addition angled or curved toward each other, as shown in FIG. 3. This angling can help them grip the head of a user. In addition there may be a coating on the bi-stable material for comfort, grip, safety, marking, encapsulation, protection or aesthetics. The coating may be a silicone, rubber or similar material. In the preferred embodiment the bi-stable material is a metal, such as, but not limited to a stainless steel, but may also be a plastic, composite or other material. An activated material that retains one form with energy and another with removal of that energy may also be used. The folding, curving or bending of the arms may also be controlled, for example the arms may have parts that prevent folding 14, and parts that allow folding 15 such as shown in FIG. 8. The arms are sized to fit the user's head and also for the size of object they will fold around when in the folded position. The arms 6 and 8 may also be removable as shown in FIGS. 9 and 10. This may allow replacement due to breakage, resizing needs, or change of look of the arm.

The first or unfolded position of the glasses frame 1 is shown in FIG. 1 for example. In this extended format the glasses 1 can be used by a user and placed on their head, for example to read. In a second or folded position or condition the glasses are folded about the hinge 5 as shown in FIGS. 2, 4 and 6. The arms 6 and 8 are allowed also to fold to then retain the glasses 1 to an elongate object 9, such as a wrist or arm as shown in FIGS. 5 and 7.

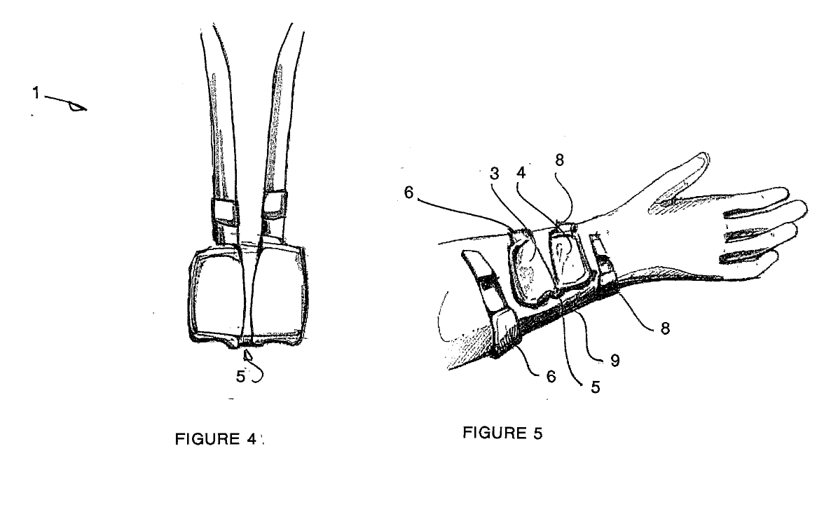

In one preferred form of the present invention the first lens holding portion 3 and second lens holding portion 4 move about the hinge 5 to lie side by side each other, for example as shown in FIGS. 2, 4 and 6. In this form the axis of movement 10 is substantially perpendicular to the major surface 11 of the lens 2. Shown in FIG. 4 the hinge 5 may be a multi-element hinge by using an additional hinge portion 17 hinged at pivot points 5A and 5B that extends the hinge 5 to accommodate better folding, this may also form the bridge of glasses 1.

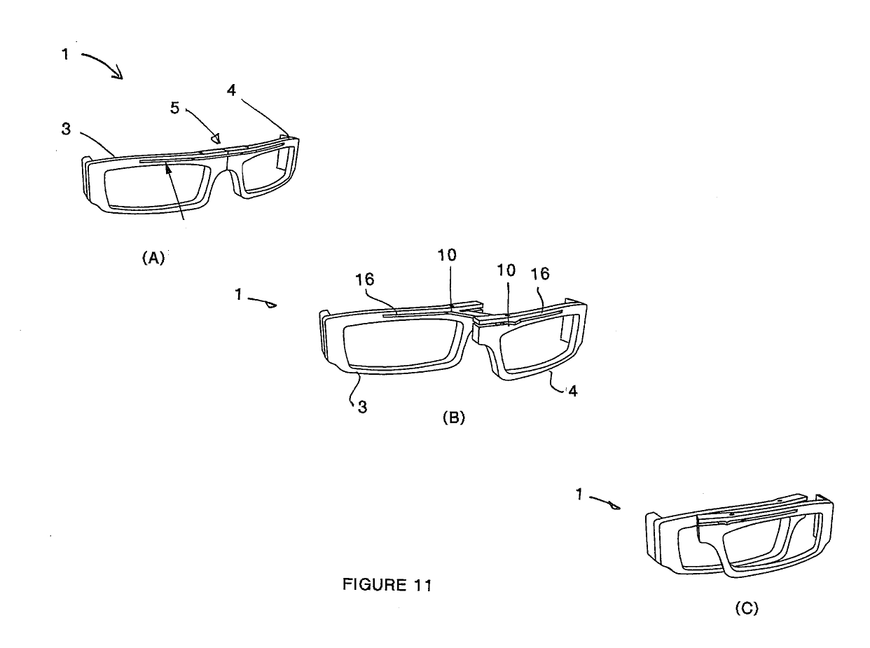

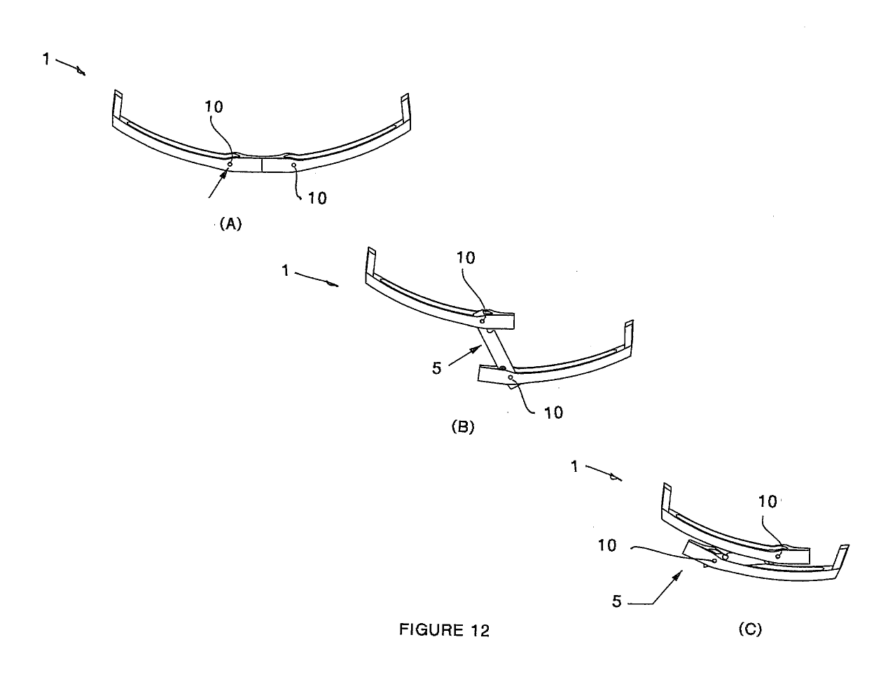

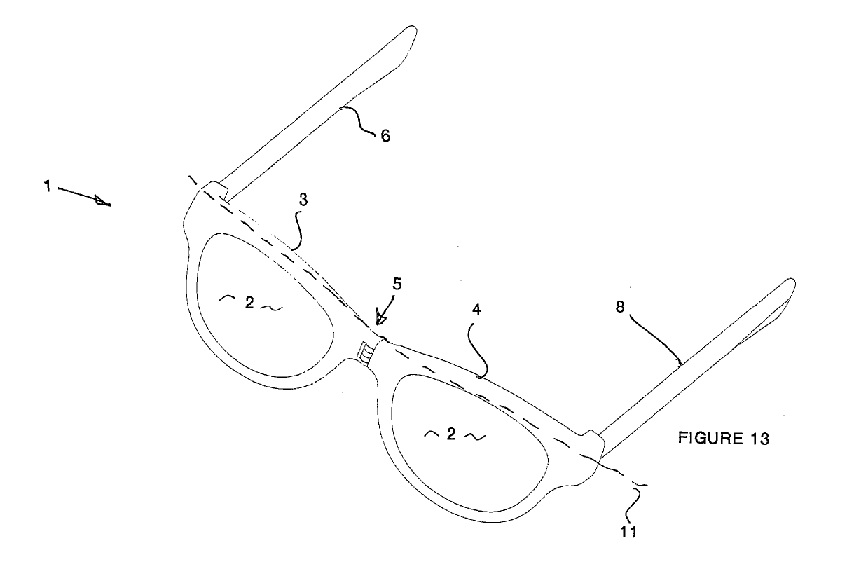

In another form of the present invention the hinge 5 (whether single or multiple element hinge) allows the lens holding portions 3 and 4 to rotate and lie one on top of another as shown in FIGS. 11 and 12 with the arms omitted for clarity and 13 through 21 including the arms 6 and 8. In this embodiment the hinge(s) 5 allow the lens holding portions to displace out of the major surface to lie on top of each other. The hinge 5 is a dual pivoting one, with each pivot having an axis of movement 10 substantially in the plane of the lens holding portions 3 and 4 respectively. A locking mechanism (not shown) may also hold the hinge open (as shown in FIGS. 11A and 12A)—the locking mechanism may be a detent or be biased and require release before folding can occur. The hinge in the embodiment shown resides in a slot 16 in each portion 3 and 4. Other locations for the hinge will now be apparent to a person skilled in the art. The actuation of the hinge 5 is shown in FIGS. 11B and 12B. The closed position is shown in FIGS. 11C and 12C. From here the glasses frame 1 can be attached as earlier described by curling of the arms.

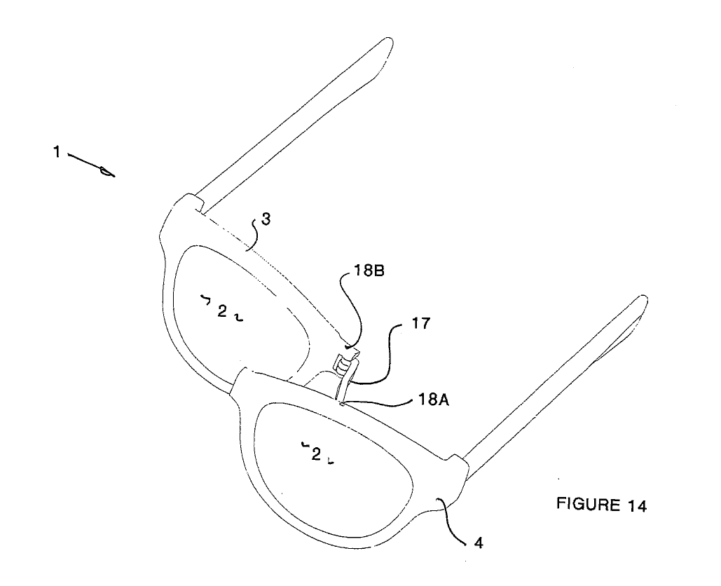

FIGS. 13 through 21 show a minor variation of the glasses frame 1 to that shown in FIG. 11—in this variation the hinge portion 17 is substantially hidden. The hinge portion 17 is shown in FIGS. 14, 16, and 17B when the glasses 1 are partially folded. The hinge axes 18A on the second lens portion 4 and 18B on the first lens portion 3 both lie substantially in the plane of the major surface 11 (for example when unfolded).

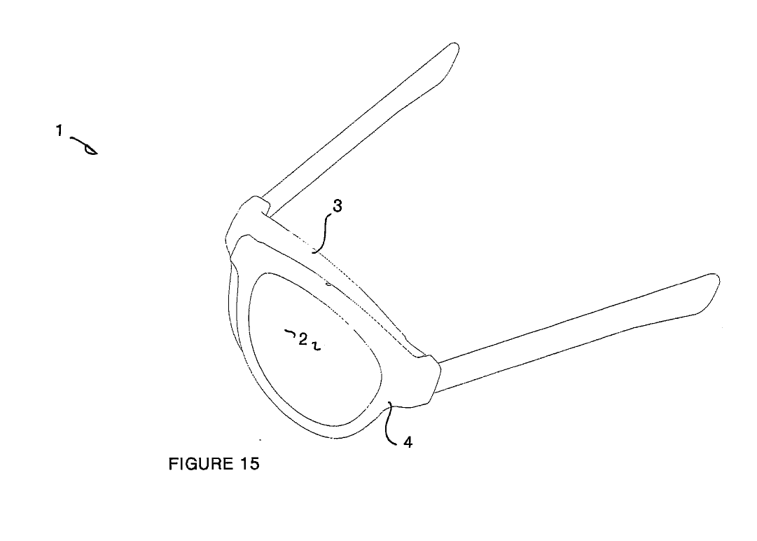

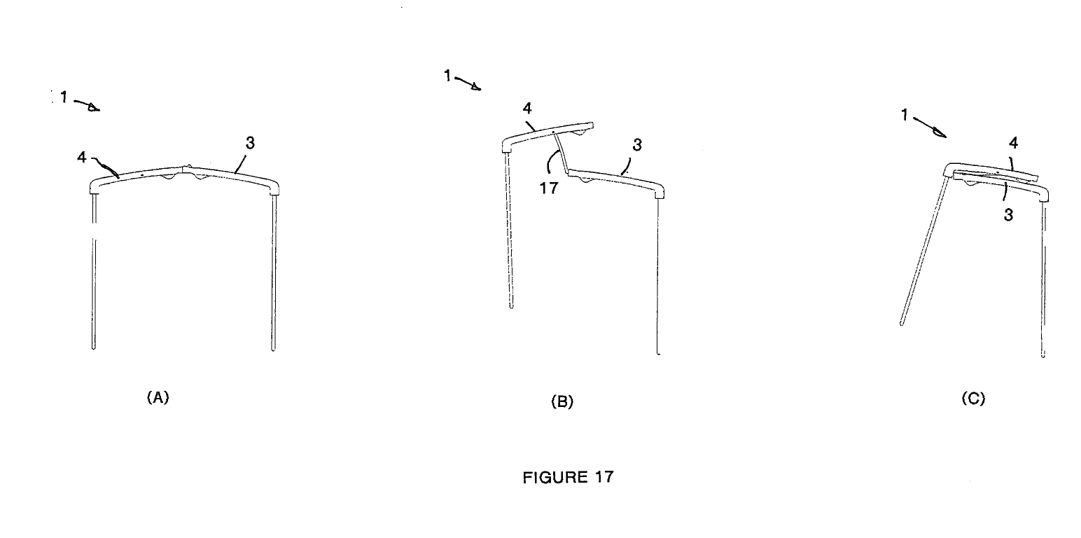

When the lens holding portions 3 and 4 are folded as shown in FIGS. 15 and 17C they lie substantially one on top of another. This also provides an element of protection to the lenses 2. The full sequence of unfolded to folded of the lens holding portions 3 and 4 is best seen in FIGS. 17(A) through (C), and in reverse in 18(A) through (C).

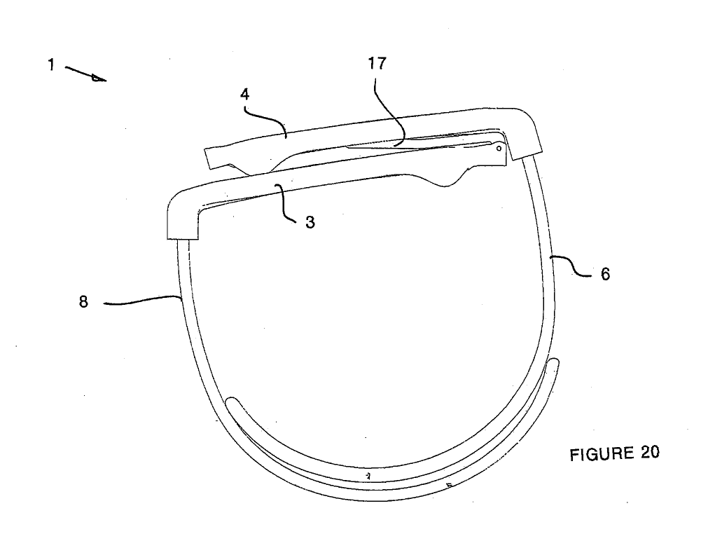

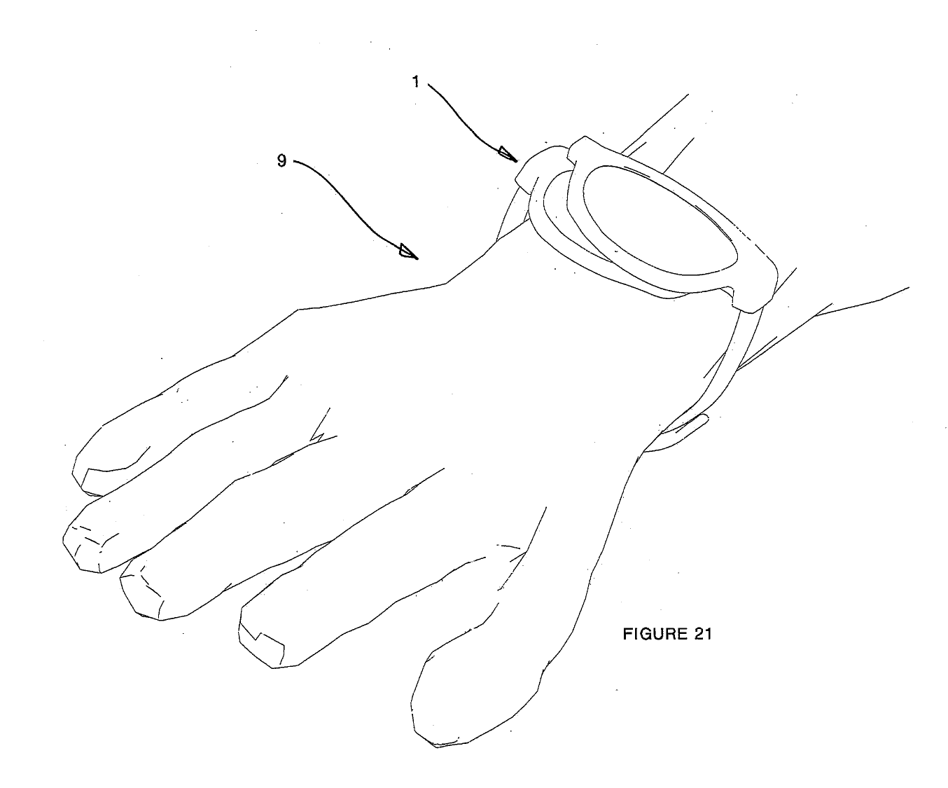

The curving, folding or wrapping of the arms 6 and 8 can be seen in FIGS. 19 and 20. The bi-stable material that preferably constitutes them moves to its wrapping position. Shown in FIG. 21 are the glasses 1 folded and wrapped about an elongate object 9, in this case the wrist of a user.

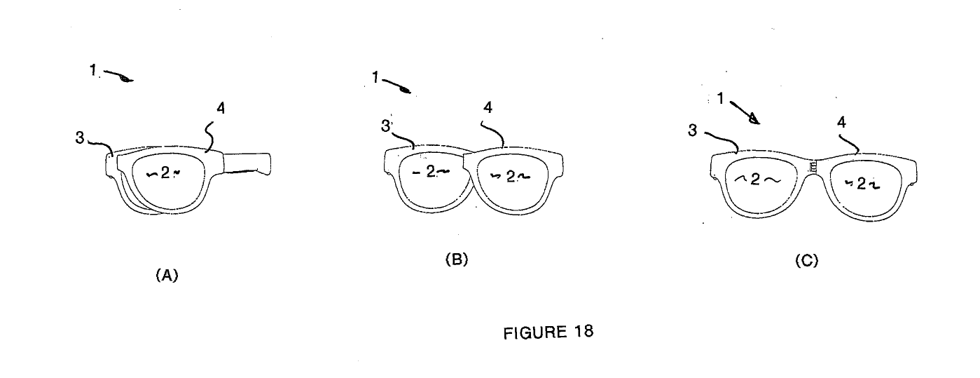

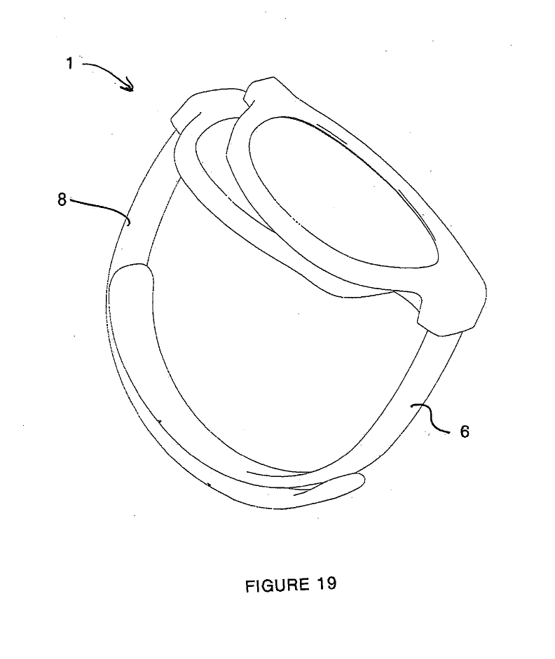

To prepare them for wearing again the glasses 1 are pulled from the wrist and the lens holding portions 3 and 4 unfolded as per FIGS. 18(A) through (C), and the arms 6 and 8 are then pulled straight and they then retain their straightened position. Alternatively the arms 6 and 8 may be straightened first and then the portions 3 and 4 unfolded.

The elongate object 9 the glasses frame 1 can be attached to may be a body part, such as a wrist as shown in FIGS. 5 and 21, or may be an arm, leg or similar. The elongate object 9 may also be a strap, handle or similar, such as for example the strap or handle of a bag. Alternatively the elongate object 9 may be a hook, pipe or other similar object, anything really that is convenient which the user may secure the glasses 1 to when not in use.

There may also be a cover 12 present to cover the lenses 2 when not in use, for example when folded. The cover may be attached to the glasses frame, or may be separate.

In a less preferred form the hinge 5 may have an axis of movement 10 that is in the major surface, thus allowing relative movement again by rotation out of the major surface, such as shown in FIG. 7.

The foregoing description of the invention includes preferred forms thereof. Modifications may be made thereto without departing from the scope of the invention.

What we claim is:

1. A glasses frame adapted to hold at least a pair of lenses, one each for an eye of a user, comprising or including,
A first lens holding portion and a second lens holding portion adapted to each hold a said lens, having at least one hinge therebetween,
A first arm extending from said first lens holding portion on an edge thereof distal from said hinge, and a second arm extending from said second lens holding portion on an edge thereof distal from said hinge,
Wherein said glasses frame has
an unfolded position whereby said first lens holding portion and said second lens holding portion are extended on said hinge to enable location of said lenses in front of each said eye and said arms extend backward from said frame to engage with a head of said user, and
a folded position whereby said first lens holding portion and said second lens holding portion are contracted about said hinge to lie toward or adjacent each other and said arms fold such that a free end of each folds towards said hinge to thereby enable capture and retention of said glasses frame to an elongate object.

2. A glasses frame as claimed in claim 1 wherein an axis of movement of said at least one hinge is substantially perpendicular to a major surface of said first and second lens holding portions when in said unfolded position.

3. A glasses frame as claimed in claim 1 wherein an axis of movement of said at least one hinge is substantially parallel to a major surface of said first and second lens holding portions when in said unfolded position.

4. A glasses frame as claimed in any one of claims 1 to 3 wherein said first lens holding portion and said second lens holding portion when in said folded position lie side by side each other.

5. A glasses frame as claimed in any one of claims 1 to 3 wherein said first lens holding portion and said second lens holding portion when in said folded position lie substantially one on top of each other.

6. A glasses frame as claimed in any one of claims 1 to 5 wherein said first and said second arm extend substantially parallel to each other at least when in said unfolded position.

7. A glasses frame as claimed in any one of claims 1 to 6 wherein said arms at least in part comprise a bi-stable material that extends for said unfolded position, and that folds or wraps for said folded position.

8. A glasses frame as claimed in claim 7 wherein said bi-stable material is a plastics, composites or metal material.

9. A glasses frame as claimed in either of claim 7 or 8 wherein said bi-stable material is coated with a soft or rubber like material.

10. A glasses frame as claimed in any one of claims 1 to 9 wherein each said lens holding portion extends substantially all the way about each said lens.

11. A glasses frame as claimed in any one of claims 1 to 10 wherein each said lens holding portion extends only part way around each said lens.

12. A glasses frame as claimed in any one of claims 1 to 11 wherein each said lens holding portion is a unitary part.

13. A glasses frame as claimed in any one of claims 1 to 11 wherein each said lens holding portion is comprised of multiple parts.

14. A glasses frame as claimed in any one of claims 1 to 13 wherein said at least one hinge is at least in part biased to either or both said folded or unfolded positions.

15. A glasses frame as claimed in any one of claims 1 to 14 wherein said glasses frame can lock or be retained in either or both said folded and said unfolded positions.

16. A glasses frame as claimed in claim 15 wherein said lock or retention is at least in part achieved by said at least one hinge.

17. A glasses frame as claimed in any one of claims 1 to 16 wherein at least when in said folded position said lenses are substantially covered, for example to prevent them becoming contaminated or scratched.

18. A glasses frame as claimed in any one of claims 1 to 17 wherein there are two said hinges.

19. A glasses frame as claimed in any one of claims 1 to 18 wherein said hinge has two hinge axes distal from each other and connected therebetween by a hinge portion.

20. A glasses frame as claimed in claim 19 wherein said hinge axes are parallel to each other and line parallel to said major surface.

21. A glasses frame as claimed in claim 18 wherein each of said two hinges is located either side of a nose piece that is intermediate each of said lens holding portions.

22. A glasses frame as claimed in any one of claims 1 to 21 wherein each said arm portion is selectively detachable from their respective said lens holding portion.

23. A glasses frame as claimed in any one of claims 1 to 22 wherein said lenses are selected from any one or more of
prescription lenses,
sunglass lenses, and
protective lenses.

24. A glasses frame as claimed in any one of claims 1 to 23 wherein said elongate object is a part of a user's body, for example an arm, wrist or leg.

25. A glasses frame as claimed in any one of claims 1 to 23 wherein said elongate object is a strap, handle or similar.

26. A glasses frame as claimed in any one of claims 1 to 25 wherein said arms angle or curve inwardly toward each other when in the unfolded position.

27. A glasses frame, comprising or including,
A first lens holding portion and a second lens holding position located either side of at least one hinge therebetween,
A first arm extending from said first lens holding portion at a location distal from said hinge,
A second arm extending from said second lens holding portion at a location distal from said hinge,
Said glasses frame having,
a first position whereby said lens holding portions and said arms are extended to enable location of said glasses frame on an users head, and
a folded position whereby said lens holding portions are rotated to locate adjacent one another, and said arms can curl to thereby hold said glasses frame to an elongate object.

28. A glasses frame as claimed in claim 28 wherein said lens holding portions and said arms in act in conjunction to hold said glasses frame to said elongate object.

29. A method of use of a glasses frame, comprising or including the steps of,
Folding a first lens holding portion and a second lens holding portion about a hinge therebetween such that said lens holding portions lie adjacent one another,
Folding a first arm, extending from said first lens holding portion and a second arm extending from said second lens holding portion,
Allowing said folded first arm and said folded second arm to wrap or otherwise locate about an elongate object,
And vice versa,
Such that said glasses frame can be stored in a folded position on said elongate object, and then unfolded for use.

30. A glasses frame as described herein with reference to any one or more of the accompanying drawings.

31. A method of use of a glasses frame as described herein with reference to any one or more of the accompanying drawings.
